(19) United States
(12) Patent Application Publication
(10) Pub. No.: US 2026/0233386 A1
(43) Pub. Date: Aug. 13, 2026

(54) ROBOT INTEGRATED MANAGEMENT APPARATUS FOR HYPER ROBOT IMPLEMENTATION AND OPERATING METHOD OF SAME APPARATUS

(71) Applicant: INTEGRIT INC., Seoul (KR)

(72) Inventor: Chang Seok LEE, Uiwang-si, Gyeonggi-do (KR)

(73) Assignee: INTEGRIT INC., Seoul (KR)

(21) Appl. No.: 19/153,630

(22) PCT Filed: Mar. 6, 2024
(86) PCT No.: PCT/KR2024/002853

§ 371 Date: Aug. 5, 2025

(30) Foreign Application Priority Data
Apr. 18, 2023 (KR) 10-2023-0050891

(51) Int. Cl. B25J 9/16

(52) U.S. Cl. CPC B25J 9/1602

(57) ABSTRACT

The present invention relates to a robot integrated management apparatus for hyper robot implementation and an operating method of the apparatus, wherein the robot integrated management apparatus for hyper robot implementation, according to an embodiment of the present invention, may comprise: a communication interface unit for communicating with a heterogeneous robot provided in an arbitrary space; and a control unit that installs, in each heterogeneous robot, a manager code (F-code) for integrally managing the heterogeneous robot, and collects and analyzes data of a robot that has been successfully authenticated by authenticating the heterogeneous robot on the basis of code information of the manager code.

### TECHNICAL FIELD

The present invention relates to an integrated robot management device for hyper robot implementation and a method of operating the device, and more particularly, to an integrated robot management device for hyper robot implementation that integrally controls different kinds of multiple robots and mobility and has an integrated authentication scheme for remote control, and a method of operating the device.

### Background Art

Commonly used peripherals of smart devices include storage devices (e.g., a memory, a disk, etc.), input devices (e.g., a keyboard, a mouse, etc.), output devices (e.g., a monitor, a speaker, a printer, etc.), and the like. Smart devices and peripherals use wired (e.g., Universal Serial Bus (USB)) or wireless (e.g., Bluetooth) connections to communicate data. Meanwhile, according to the way robots for various purposes, such as domestic purposes, industrial purposes, etc., are operated, it is general for the robots to utilize their own central computing devices to make complex decisions and perform control. However, it has recently become commonplace for the public to utilize smart devices, such as cellular phones or tablet personal computers (PCs), to access complex computing-based services.

Regarding a robot's computing device, rather than having expensive hardware inside the robot, one alternative is to utilize computing power of an external smart device. To realize this method, the robot should be registered as a peripheral device of the smart device and be able to receive commands from the smart device on the basis of data communication using a connection method, such as USB, Bluetooth, etc., and execute the commands. In a control environment where a robot operates as a peripheral device under the control of a smart device, control software created by the robot's manufacturer should be installed on the smart device to control the robot.

However, in industrial fields or among general consumers, there are many cases where different kinds of robots are purchased and utilized depending on price, robot performance, the timing of purchasing a robot, etc. Accordingly, there is great inconvenience in managing different kinds of robots.

For example, since the number of robots is gradually increasing and kinds of robots are increasing accordingly, replacing humans increases work productivity, but administrative complexity and time also increase. Therefore, it is necessary to develop a system for integrally controlling operations of managing various kinds of robots.

### Related Art Document

### Patent Document

(Patent document 1) Korean Patent No. 10-1253561 (Apr. 5, 2013)
(Patent document 2) Korean Patent No. 10-1331852 (Nov. 15, 2013)
(Patent document 3) Korean Patent No. 10-2067770 (Jan. 13, 2020)
(Patent document 4) Korean Unexamined Patent Application No. 10-2015-0074375 (Jul. 2, 2015)
(Patent document 5) Korean Unexamined Patent Application No. 10-2015-0059713 (Jun. 2, 2015)

### DISCLOSURE

### Technical Problem

An object of embodiments of the present invention is to provide an integrated robot management device for hyper robot implementation that integrally controls different kinds of multiple robots and mobility and has an integrated authentication scheme for remote control, and a method of operating the device.

### Technical Solution

An integrated robot management device for hyper robot implementation according to an embodiment of the present invention includes a communication interface unit configured to communicate with different kinds of robots provided in a space and a control unit configured to install a manager code (F-code) for integrally managing the different kinds of robots on each of the different kinds of robots, authenticate the different kinds of robots on the basis of code information of the manager code, and collect and analyze data of robots that have been successfully authenticated.

The control unit may designate the different kinds of robots in the same space as a group and provide a service on the basis of the designated group.

The control unit may simultaneously perform operations of updating the manager code for the different kinds of robots designated as the group.

The control unit may provide analysis results of big data related to the different kinds of robots upon request from manufacturers of the different kinds of robots.

The control unit may use manufacturer information, model information, function code information for categorizing each robot model specification and functional characteristics, registration categorization information indicating versions and registration dates of the robots, and categorization information indicating assignment codes and sequence numbers for the services and schedules of the robots which are included in a data format of the manager code.

A method of operating an integrated robot management device for hyper robot implementation according to an embodiment of the present invention includes communicating, by a communication interface unit, with different kinds of robots provided in a space and installing, by a control unit, a manager code (F-code) for integrally managing the different kinds of robots on each of the different kinds of robots, authenticating the different kinds of robots on the basis of code information of the manager code, and collecting and analyzing data of robots that have been successfully authenticated.

The method may further include designating the different kinds of robots in the same space as a group and providing a service on the basis of the designated group.

The providing of the service may include simultaneously performing operations of updating the manager code for the different kinds of robots designated as the group.

The method may further include providing, by the control unit, analysis results of big data related to the different kinds of robots upon request from manufacturers of the different kinds of robots.

The collecting and analyzing of the data may include using manufacturer information, model information, function code information for categorizing each robot model specification and functional characteristics, registration categorization information indicating versions and registration dates of the robots, and categorization information indicating assignment codes and sequence numbers for services and schedules of the robots which are included in a data format of the manager code.

### Advantageous Effects

According to an embodiment of the present invention, a MINE scheme, a media access control (MAC) address scheme, etc., verified in existing mobile devices and network systems are called, but a separate identification and authentication scheme is implemented for an integrated service of a robot system. Accordingly, based on this, it is possible to secure an authentication and registration scheme optimized for the running and services of machines in a robot site while improving security.

In addition, an embodiment of the present invention provides a rapid robot commercialization environment for developers and robot companies through a technical support site and also supports all steps for verification and commercialization of robot datasets through service registration at a development board stage to support the entire robot commercialization cycle from a development step to the operation, management, and update of multiple robots after the launch.

### DESCRIPTION OF DRAWINGS

FIG. 1 is a diagram showing a structure of an integrated robot management system according to an embodiment of the present invention.

FIG. 2 is a diagram schematically showing an operating process of the system of FIG. 1.

FIGS. 3 to 5 are diagrams illustrating a security authentication scheme according to the embodiment of the present invention.

FIG. 6 is a block diagram illustrating a detailed structure of an integrated robot management device of FIG. 1.

FIG. 7 is a flowchart illustrating an operating process of the integrated robot management device according to another embodiment of the present invention.

### BEST MODE

Hereinafter, embodiments of the present invention will be described in detail with reference to the drawings.

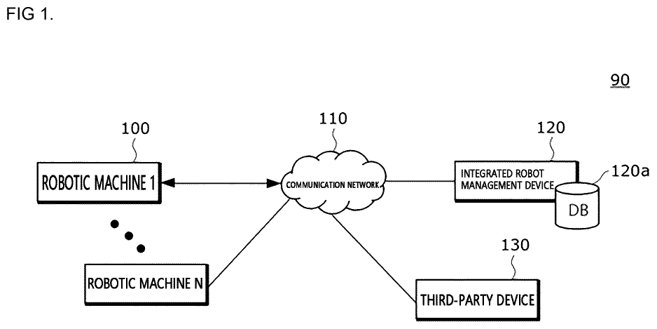

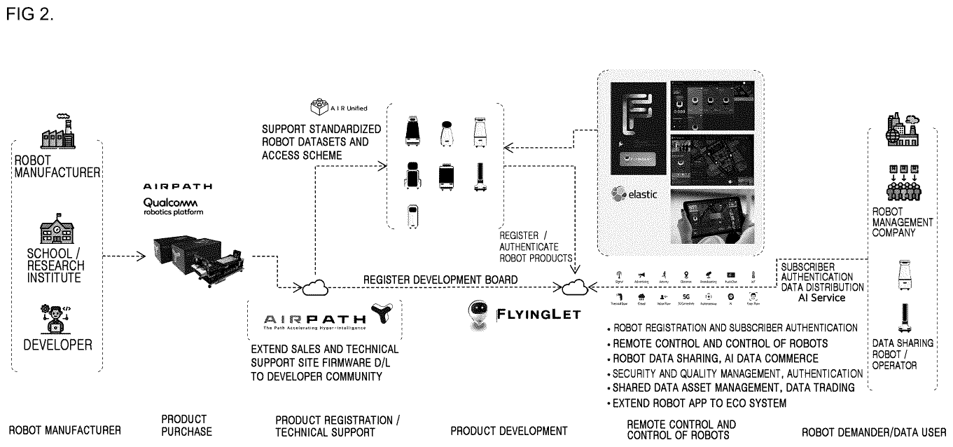

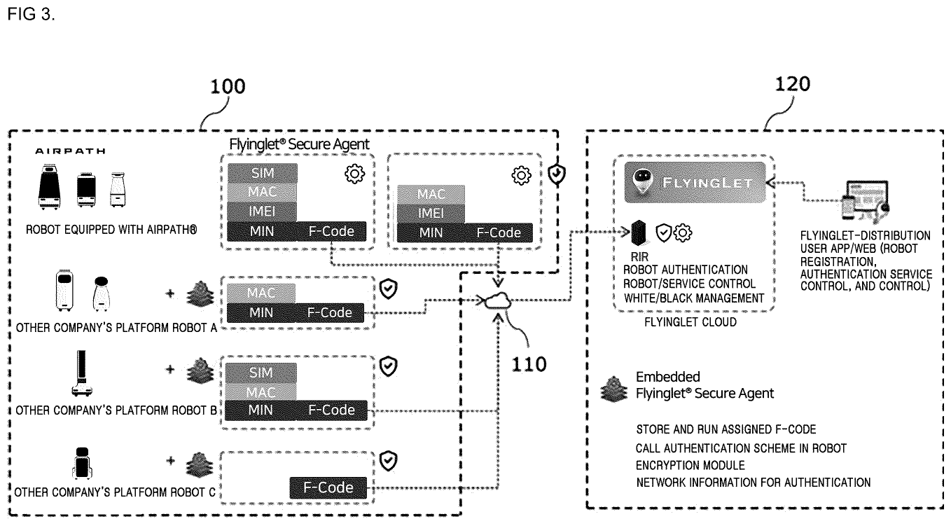

FIG. 1 is a diagram showing a structure of an integrated robot management system according to an embodiment of the present invention, FIG. 2 is a diagram schematically showing an operating process of the system of FIG. 1, and FIGS. 3 to 5 are diagrams illustrating a security authentication scheme according to the embodiment of the present invention.

As shown in FIG. 1, an integrated robot management system 90 according to the embodiment of the present invention includes some or all of different kinds of robotic machines 100, a communication network 110, an integrated robot management device 120, and a third-party device 130.

Here, “including some or all” means that the integrated robot management system 90 may be configured without some components, such as the third-party device 130 or some or all components of the integrated robot management device 120 may be integrated with a network device (e.g., a wireless exchange device or the like) constituting the communication network 110. To aid in overall understanding of the present invention, the following description is based on the assumption that all the components are included.

The robotic machines 100 according to the embodiment of the present invention include different kinds of robots. Robots are made by several manufacturers and available on the market. Robots are of several kinds and have several specifications, and there are low-cost robots and very high-end robots. Hardware (H/W), software (S/W), etc., of low-cost robots may correspond to low specifications, while high-end robots may include high-specification H/W and S/W. Low specifications or high specifications may correspond to performance of a robot. Robots of different types, such as different models, specifications, etc., may be referred to as different types of robots.

Robots according to the embodiment of the present invention, that is, the robotic machines 100, may include not only various kinds of robots using an International Mobile Equipment Identity (IMEI), a media access control (MAC) address, and a subscriber identity module (SIM) used in mobile communication, but also robots with no corresponding IMEI, MAC address, or SIM. In the case of a robot that is incapable of mobile communication, communication can be performed after a manager code referred to as an F-code which is supplied by accessing a service of, for example, the integrated robot management device 120 of FIG. 1 is installed. In the case of a robot with an IMEI, a MAC address, and a SIM, an F-code for authentication and registration of the robot can be installed for integral management by the integrated robot management device 120 of FIG. 1. Accordingly, embodiments of the present invention are not limited to any one type of robot. Regarding authentication schemes for authentication and registration of robots, IMEI, MAC address, SIM, and F-code may be compared and summarized as shown in Table 1.

TABLE 1

| | | | MAC | | |
|---|---|---|---|---|---|
| | F-code | IMEI | address | SIM | Notes |
| Standard | Integrit's | OMA/3GPP | IEEE802 | OMA/3GPP | |
| | proprietary | | | | |
| Definition | Specifies | A unique | Used as a | Authentication | |
| and | features, | numbering | logical | is performed | |
| overview | specifications, | system for | network | by exchanging | |
| | and version | mobile | address | an ICCID and | |
| | information | devices that | including | IMSI | |
| | of robots and | specifies the | Ethernet and | embedded in a | |
| | the makes, | manufacturer | Wi-Fi. It is | SIM with a | |
| | models, and | and model, | assigned by | network end | |
| | model names | and is used for | an NIC | HLR and AuC | |
| | of robots. | selective | vendor and | | |
| | A system of | authentication, | encoded in | | |
| | service | restriction, | the | | |
| | feature codes | and blocking | hardware. | | |
| | that are | by operating | | | |
| | generated and | entities such | | | |
| | assigned | as carrier lock, | | | |
| | during the | country lock, | | | |
| | registration | etc., with a | | | |
| | process of a | separate | | | |
| | location, a | IMNE list | | | |
| | place, a | | | | |
| | purpose, etc. | | | | |
| Fluidity | Fluid, and | Fixed, and can | Can be | Fixed, high | |
| and | security can | be damaged | modified or | security | |
| security | be enhanced | | changed by a | | |
| | | | manager | | |
| Problems | | IMEI cannot | In the case | SIM | There is MN |
| upon | | be used to | of replacing | replacement | system ESN |
| application | | identify | a robot's | requires | identification, |
| to robot | | detailed | Wi-Fi NIC, | changes and | but this is |
| system | | features, | re-registration | modifications, | difficult to |
| | | software | MAC can be | and there is no | issue and |
| | | version | modified | authentication | assign as an |
| | | information, | | method at the | integrated |
| | | etc., of robots | | stage of not | system of |
| | | with complex | | utilizing a | robot |
| | | specifications | | mobile | manufacturers |
| | | | | network | |
| Notes | See cases of | IMEI is not | Manipulable, | 5G-specific | |
| | Pulurobotics, | actually used | insecure, and | networks and | |
| | Universal | in robots | vulnerable to | NAS users | |
| | Robots, and | | network | require a | |
| | CYCOGS | | blackouts | separate | |
| | | | | module | |

For example, the robotic machine 100 according to the embodiment of the present invention may access the integrated robot management device 120 of FIG. 1 using, for example, a MAC address. However, during this process, data about operations or a surrounding situation of the robotic machine 100 may be collected and transmitted, and interoperation with other kinds of robots is possible using an F-code scheme. For example, when different kinds of robots work in the same space, the robots may register their identification information to communicate with each other for smooth operation.

The communication network 110 includes both wired and wireless communication networks. For example, wired and wireless Internet networks may be used or interoperate as the communication network 110. Here, the wired network includes Internet networks such as a cable network and a public switched telephone network (PSTN), and the wireless communication network includes a code division multiple access (CDMA) network, a wideband CDMA (WCDMA) network, a Global System for Mobile Communications (GSM) network, an Evolved Packet Core (EPC) network, a Long Term Evolution (LTE) network, a WiBro network, etc. The communication network 110 according to the embodiment of the present invention is not limited thereto, and for example, cloud computing networks under cloud computing environments, 5^{th} generation (5G) networks, etc., may be used as a connection network for next-generation mobile communication systems to be implemented in the future. For example, when the communication network 110 is a wired communication network, access points in the communication network 110 may access a telephone exchange or the like, but when the communication network 110 is a wireless communication network, data may be processed by accessing a serving general packet radio service (GPRS) support node (SGSN) or a gateway GPRS support node (GGSN) run by a communication service provider or by accessing various relays such as a base transceiver station (BTS), a node base station (NodeB), an evolved NodeB (e-NodeB), etc.

The communication network 110 may include access points. The access points include small base stations such as femto-base stations or pico-base stations commonly installed in buildings. Here, femto-base stations or pico-base stations are classified depending on the maximum number of different kinds of robotic machines 100, etc., accessible in terms of classifications of small base stations. The access points include a short-range communication module for performing short-range communication, such as ZigBee, Wi-Fi, etc., with the different kinds of robotic machines 100, etc. For wireless communication, the access points may use transmission control protocol/Internet protocol (TCP/IP) or real-time streaming protocol (RTSP). Here, short-range communication may be performed in accordance with various standards including Bluetooth, ZigBee, Infrared Data Association (IrDA), radio frequency (RF), such as ultra-high frequency (UHF) and very high frequency (VHF), ultra-wideband (UWB), etc., in addition to Wi-Fi. Accordingly, access points may extract a location of a data packet, designate an optimal communication path for the extracted location, and forward the data packet to the next device, for example, the integrated robot management device 120, along the designated communication path. The access points may share several lines in a general network environment and include, for example, a router, a repeater, a relay, etc.

The integrated robot management device 120 integrally controls different kinds of multiple robots and mobility and has an integrated authentication scheme for remote control. For example, the integrated robot management device 120 according to the embodiment of the present invention may have a system in which different kinds of robots exchange data and interoperate with each other, and then the different kinds of robots with different standards, functions, and specifications are bound with a single service and provide services to each other. Through basic authentication of a robot, the integrated robot management device 120 should know whether the robot is actually available, what kind of robot it is, and whether the robot can receive data that it is given, and then may transmit and receive data. Therefore, identifying a robot (using identification information, etc.) is authentication and registration, and for this purpose, the integrated robot management device 120 may perform related operations.

To perform the above operations, the integrated robot management device 120 may use various methods. However, since there are several kinds of robots and there are low-cost robots and high-end robots in terms of specifications, it is necessary to register and authenticate low-cost robots and high-cost robots. Therefore, in the embodiment of the present invention, IMEIs, MAC addresses, and SIMs which are used in existing mobile communication are used, and robots different from existing robots create, that is, generate, manager codes referred to as F-codes for robots with no IMEI, MAC address, or SIM. The codes are used to register robots, manage kinds of robots, and categorize functions and specifications. Accordingly, an integrated authentication scheme can be utilized to use robots.

FIG. 2 is a diagram schematically showing an operating process of the system of FIG. 1. Based on the technical support of the integrated robot management device 120 of FIG. 1, it is possible to provide a rapid robot commercialization environment for developers and robot companies included in the category of the third-party device 130 of FIG. 1, and at the same time, support all steps for verification and commercialization of robot datasets through registration of a service (of FlyingLet) at a development board stage to support the entire robot commercialization cycle from a development step to the operation, management, and update of multiple robots after the launch. In other words, when multiple kinds of robots are integrally run and managed, the integrated robot management device 120 may generate big data using data collected from the multiple kinds of robots and derive various analysis results required for developers and robot companies through analyzing the big data. Providing the analysis results enables management of robots from a development step even after the launch.

The integrated robot management system 90 or the integrated robot management device 120 of FIG. 1 according to the embodiment of the present invention should prepare for network blackouts and different network environments at robot sites and control machines, such as robots, etc., and port services from a user's perspective. In this context, to implement a single scheme for robots with different functions and specifications required by various robot manufacturers and provide integrated services, existing authentication schemes for mobile communication devices cannot be used. Therefore, a robotics platform, that is, service, provided by the integrated robot management device 120 of FIG. 1 calls a MINE scheme, a MAC address scheme, etc., verified in existing mobile devices and network systems, and implements a separate identification and authentication scheme for an integrated service of a robot system. Based on this, it is possible to secure an authentication and registration scheme optimized for running and service of machines at robot sites while improving security.

FIG. 3 is a diagram illustrating a structure and functions of a security agent, that is, an S/W module, referred to as FlyingLet. A FlyingLet secure agent embedded in the integrated robot management device 120 of FIG. 1 which operates as a robotics platform calls IMEI, MAC, SIM, and MIN information embedded in the platform and combines the information with a specialized F-code scheme to build an enhanced authentication scheme. In addition, the FlyingLet secure agent which is provided to secure an authentication scheme even in most robot systems that do not have an authentication scheme in accordance with specific functions and specifications, enables general robot systems equipped with the FlyingLet secure agent to provide minimized authentication requirements for interoperation and compatibility with robots and robot services.

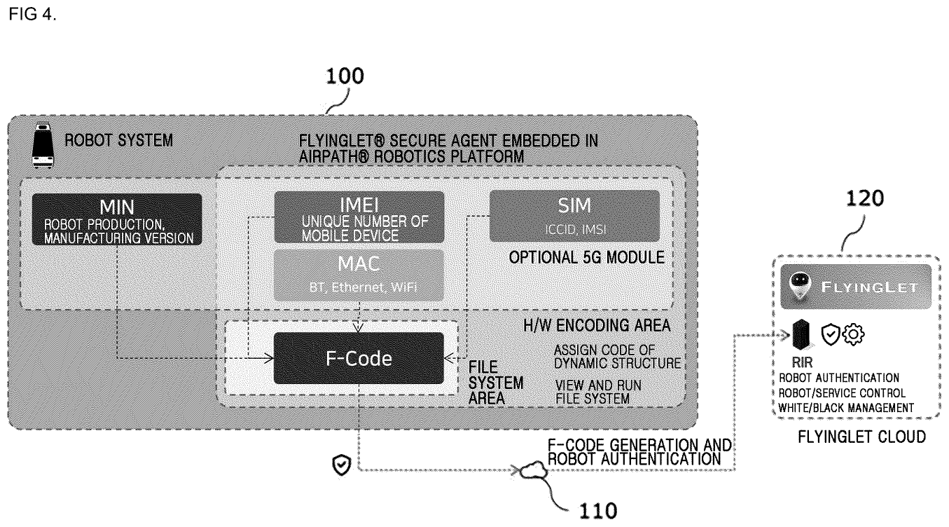

FIG. 4 is a diagram illustrating an authentication scheme of an F-code for an integrated robot service. An F-code may be generated to build an effective authentication scheme that performs control for an integrated service for multiple robots and is intended to integrally manage robotic machines and datasets and control services in the control cloud FlyingLet. When a robot manager with authorized rights in FlyingLet sets and registers a manufacturer, a model, a function, a service, etc., of a robotic machine, an F-code is generated and activated in the system, transmitted to a FlyingLet secure agent installed in the robotic machine, and stored in a firmware file system of the robot, and the F-code may be utilized as a minimum scheme for authentication of the machine and service operation until reset by an authorized manager. Here, the authentication of the robot manager may be based on authentication information made when registering for a service of the integrated robot management device 120 of FIG. 1. As shown in FIG. 4, the F-code is a scheme that defines and categorizes robotic machines, specifications, and services, and can improve security through encoding for encryption and an encryption key scheme for authentication of the FlyingLet secure agent. However, the F-code may not guarantee data completeness or data security.

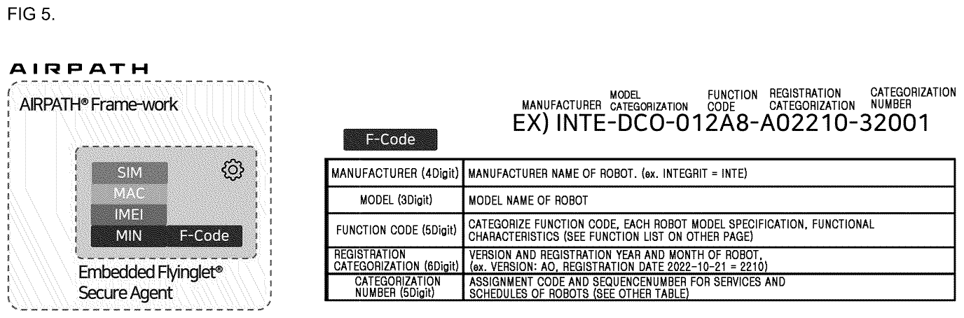

FIG. 5 is a diagram illustrating a countermeasure of an authentication scheme according to robot specifications. For example, a FlyingLet secure agent embedded in the robotics platform AirPath calls IMEI, MAC, SIM, and MIN information embedded in a robot and combines the information with a specialized F-code scheme to perform authentication. In other words, in the case of the robotic machines 100 of FIG. 1, F-code information may be extracted to request authentication. Also, an authentication operation for such authentication may be provided by the integrated robot management device 120 of FIG. 1. Alternatively, an authentication module, for example, FlyingLet, embedded in the integrated robot management device 120 may perform authentication. The integrated robot management device 120 of FIG. 1 interoperates with a robot and a robot service and provides minimized authentication requirements to a robot system without any authentication scheme according to a specific function and specifications when a FlyingLet secure agent is installed.

The third-party device 130 of FIG. 1 may include various types of devices, such as computers, servers, etc., held by manufacturers, schools or research centers, and developers who manufacture, develop, and research the different kinds of robot machines 100 as shown in FIG. 2 and operators, etc., who operate robots or share robot-related data. More specifically, the third-party device 130 may include not only personal computer (PC)-based terminal devices, such as desktop computers, laptop computers, etc., but also mobile-based devices such as tablet PCs, smartphones, etc. In addition, smart televisions (TVs), servers, etc., may be included. In the case of a server, the third-party device 130 may interoperate with the integrated robot management device 120 of FIG. 1 through an application programming interface (API).

Relevant people or developers of manufacturers utilizing the third-party device 130 may perform user authentication after subscribing to the service of the integrated robot management device 120 of FIG. 1. Such subscription and user authentication may be possible from a robot's development stage, which may allow robot development to be performed using data from numerous different kinds of robots. For example, when a board installed in a robotic machine 100 is under development, it may be possible to register the development board, and various operations such as registering and authenticating robot products may be performed. Through this process, remote robot control and a control service may be available. In addition, the service of the integrated robot management device 120 can be used in robot data sharing or artificial intelligence (AI) data commerce.

In addition to the above description, the robotic machines 100, the integrated robot management device 120, and the third-party device 130 of FIG. 1 may perform various operations, and other details may be described below.

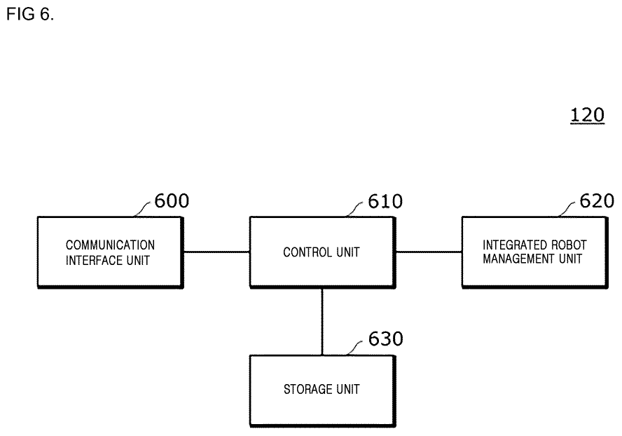

FIG. 6 is a block diagram illustrating a detailed structure of an integrated robot management device of FIG. 1.

As shown in FIG. 6, the integrated robot management device 120 according to the embodiment of the present invention includes some or all of a communication interface unit 600, a control unit 610, an integrated robot management unit 620, and a storage unit 630.

Here, “including some or all” means that the integrated robot management device 120 may be configured without some components, such as the storage unit 160 or some components such as the integrated robot management unit 620 may be integrated with another component such as the control unit 610. To aid in overall understanding of the present invention, the following description is based on the assumption that all the components are included.

The communication interface unit 600 may communicate with the robotic machines 100 of FIG. 1 to perform an operation for installing an S/W module of a security agent for performing operations according to the embodiment of the present invention. The security agent may include the above-described F-code. For example, to install a security agent program or a source code, such as an F-code, according to the embodiment of the present invention, various operations may be performed. Manufacturers that manufacture the robotic machines 100 of FIG. 1 or operators who purchase and operate the robotic machines 100 may access the integrated robot management device 120 to perform manager authentication, register information related to kinds or specifications of the robotic machines 100, and then perform corresponding operations. For example, when a robotic machine 100 is capable of wireless communication, the program or source code may be installed remotely. On the other hand, when a robotic machine 100 is incapable of communication, a manager may download and store a related program in a storage medium, such as a Universal Serial Bus (USB) memory, etc., that he or she carries or a computer and then install the program on the robotic machine 100. For example, a card such as a USB memory, etc., may be inserted, or a computer may be connected to install the program in the form of an electrically erasable programmable read-only memory (EEPROM). The communication interface unit 600 may engage in this operation.

When this installation process is completed, the communication interface unit 600 may perform an authentication and registration operation for various different kinds of robots, that is, the robotic machines 100. This robot authentication may be performed every time the robotic machines 100 transmit data, or only when the power is turned on or off. For example, when the power of a robotic machine 100 is turned off after the robotic machine 100 finishes a task and then is turned on again, an authentication operation can be performed. This authentication operation may be performed in various ways in accordance with a service policy of a service provider who provides a service according to the embodiment of the present invention, and thus is not limited to any one particular form. During this authentication process, encryption or decryption may be performed, and the communication interface unit 600 may engage in this encryption or decryption operation.

In addition, the communication interface unit 600 may periodically collect data related to robot operation from the robotic machines 100 and provide the collected data to the control unit 610. Alternatively, the collected data may be transmitted to a database (DB) 120a of FIG. 1 under the control of the control unit 610, systematically classified by identification information, etc., of the robotic machines 100, and stored.

The control unit 610 is in charge of overall control operations of the communication interface unit 600, the integrated robot management unit 620, and the storage unit 630 of FIG. 6. For example, when the third-party device 130 of FIG. 1 requests installation of an F-code according to the embodiment of the present invention on a robotic machine 100, the control unit 610 may control the integrated robot management unit 620 to perform an operation related thereto. Also, when installation of the security agent program on the robotic machine 100 is completed, the control unit 610 may control the communication interface unit 600 to control or remotely control operations of the robotic machine 100. In addition, when a robotic machine 100 requests authentication, the control unit 610 may temporarily store corresponding authentication data in the storage unit 630 and then load and provide the authentication data to the integrated robot management unit 620, receiving an authentication result. The authentication result may be provided to the robotic machine 100, and data collected thereafter from the robotic machine 100 may be stored and managed in the DB 120a of FIG. 1. Various kinds of data may be collected in the robotic machine 100, and the control unit 610 can provide corresponding data to the integrated robot management unit 620 for data processing.

The integrated robot management unit 620 may perform an operation for integrally managing different kinds of multiple robotic machines 100. To this end, the integrated robot management unit 620 may install a program for integrated management on the robotic machines 100 in advance and analyze data collected from the different kinds of robotic machines 100 on the basis of the program to operate such that the different kinds of robotic machines 100 can interoperate with each other. For example, it is assumed that different kinds of robots are used in a space such as a restaurant or a factory. In this case, managing the different kinds of robots may be very inconvenient for a manager. Therefore, the different kinds of robots can be bound with a single service and operated. The single service may be a group or an area or identification information of a space. Accordingly, when different kinds of robots are bound with a single service and it is necessary to update, for example, the program, etc., operations such as updates, etc., can be simultaneously performed. Alternatively, updates may be performed such that the different kinds of robots may have performance specialized for a space. Further, robots can exchange data and interoperate with each other. For example, when robots are bound with a single service or set as a group, one of the robots may register information on different kinds of other robots and thus can perform communication or transmit data on the basis of the registered information.

For example, it is assumed that a specific robot in a space does not have a communication module for transmitting data to the integrated robot management device 120. In this case, it may be impossible to provide data collected by the robot to the integrated robot management device 120 of FIG. 1. In this case, it is possible to transmit the data to a robotic machine 100, that is, a robot, which is currently in an idle state in the same space, to request the robotic machine 100 to transmit the data to the integrated robot management device 120. Accordingly, the integrated robot management unit 620 can integrate robotic machines 100 which are set as a single service group, etc., and perform a data analysis operation. Therefore, a manager of the space may receive various analysis results by utilizing different kinds of robots, and it is possible to efficiently operate the robotic machines 100 or, in the case of a restaurant or a factory, receive results related to running and management of the restaurant or the factory.

The storage unit 630 may temporarily store various kinds of data processed under the control of the control unit 610. For example, the storage unit 630 may temporarily store data provided by different kinds of multiple robotic machines 100 under the control of the control unit 610, load the temporarily stored data, and provide it to the integrated robot management unit 620. In addition, the storage unit 630 may temporarily store data stored in the DB 120a of FIG. 1 under the control of the control unit 610 and provide the data to the integrated robot management unit 620 for data analysis.

In addition to the above description, the communication interface unit 600, the control unit 610, the integrated robot management unit 620, and the storage unit 630 of FIG. 6 may perform various operations. Other details have been described well enough above and will not be reiterated.

The communication interface unit 600, the control unit 610, the integrated robot management unit 620, and the storage unit 630 of FIG. 6 according to the embodiment of the present invention are configured as physically separated hardware modules, but each module may store S/W for performing the above operations therein and execute the S/W. However, the S/W is a set of S/W modules, and each module can be formed as hardware. Accordingly, each module is not particularly limited to S/W or H/W. For example, the storage unit 630 may be a storage or memory which is hardware. However, it is possible to reposit information on the basis of S/W, and thus the storage unit 630 is not particularly limited thereto.

Meanwhile, according to another embodiment of the present invention, the control unit 610 may include a central processing unit (CPU) and a memory and may be formed as one chip. The CPU may include a control circuit, an arithmetic logic unit (ALU), an instruction interpreter, a registry, etc., and the memory may include a random access memory (RAM). The control circuit may perform a control operation, the ALU may perform a computation operation of binary bit information, the instruction interpreter may include an interpreter, a compiler, etc., to perform an operation of converting a high-level language into machine code or converting machine code into a high-level language, and the registry may engage in S/W-based data storage. According to the above configuration, for example, in an early operation stage of the integrated robot management device 120, a data computation processing rate can be rapidly increased by copying the program stored in the integrated robot management unit 620, loading the program onto the memory, that is, the RAM, and executing the program. In the case of a deep learning model, the deep learning model may be loaded onto a graphics processing unit (GPU) memory rather than a RAM, and the GPU may be used to accelerate the data computation processing rate.

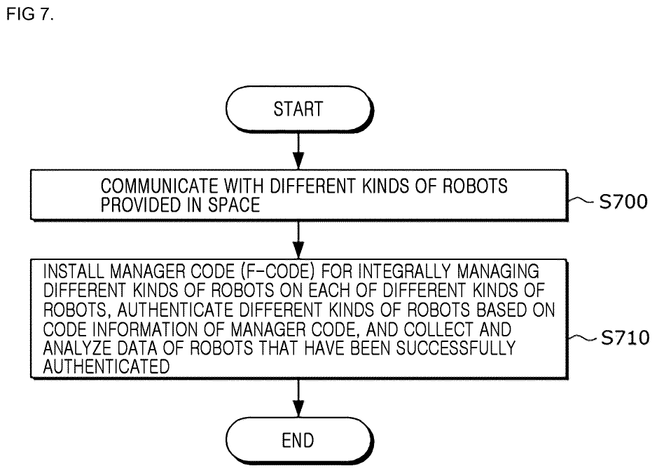

FIG. 7 is a flowchart illustrating an operating process of the integrated robot management device of FIG. 1.

Referring to FIG. 7 together with FIG. 1 for convenience of description, the integrated robot management device 120 according to the embodiment communicates with different kinds of robots provided in a space (S700). Here, the communication may refer to communication by remote control but may also include communication performed via wired cables connecting the robots to a connector, etc., or through direct communication such as Bluetooth.

In addition, the integrated robot management device 120 may install a manager code (F-code) for integrally managing different kinds of robots on each of different kinds of robots, authenticate different kinds of robots on the basis of code information of the manager code, and collect and analyze data of robots that have been successfully authenticated (S710). For example, big data related to different kinds of robots may be analyzed using an AI deep-learning program, etc., and the analysis results may be provided to manufacturers, research institutes, etc., that develop robots. In this way, it is possible to improve hardware or software of a previously developed robot and also apply the analysis results to a development board from a development stage of a robot. For example, when a problem is found in the design, function, or performance of a robot as a result of analyzing different kinds of robots, it is possible to develop or improve the robot in consideration of the problem.

In addition to the above description, the robotic machines 100, the integrated robot management device 120, etc., of FIG. 1 may perform various operations. Other details have been described well enough above and will not be reiterated.

Meanwhile, although all the components constituting embodiments of the present invention are described as being combined into one or operated by being combined with each other, the present invention is not necessarily limited to these embodiments. In other words, within the scope of the object of the present invention, all the components may be selectively combined into one or more and operated. Further, all of the components may be separately implemented as one piece of independent hardware, but some or all of the components may be selectively combined and implemented as a computer program having a program module that performs some or all of functions combined in one piece or a plurality of pieces of hardware. Codes and code segments constituting the computer program may be readily inferred by those of ordinary skill in the technical field of the present invention. The computer program may be stored in non-transitory computer-readable media and read and executed by a computer to implement an embodiment of the present invention.

Here, the non-transitory computer-readable recording media represent media that semi-permanently store data and are readable by a device, rather than media that store data for a short moment such as a register, a cache, a memory, etc. Specifically, the foregoing programs may be stored and provided in non-transitory computer-readable recording media such as a compact disc (CD), a digital versatile disc (DVD), a hard disk, a Blu-ray disc, a USB memory, a memory card, a ROM, etc.

Although exemplary embodiments of the present invention have been illustrated and described above, the present invention is not limited to the above-described specific embodiments. Without departing from the gist of the present invention stated in the claims, various modifications can be made from the present invention by those of ordinary skill in the technical field to which the present invention pertains, and these modified embodiments should not be separately understood from the technical spirit or prospects of the present invention.

1. An integrated robot management device for hyper robot implementation, comprising:
a communication interface unit configured to communicate with different kinds of robots provided in a space; and
a control unit configured to install a manager code (F-code) for integrally managing the different kinds of robots on each of the different kinds of robots, authenticate the different kinds of robots on the basis of code information of the manager code, and collect and analyze data of robots that have been successfully authenticated,
wherein the control unit designates the different kinds of robots in the same space as a group and provides a service on the basis of the designated group,
the control unit simultaneously performs operations of updating the manager code for the different kinds of robots designated as the group,
the control unit provides analysis results of big data related to the different kinds of robots upon request from manufacturers of the different kinds of robots, and
the control unit uses manufacturer information, model information, function code information for categorizing each robot model specification and functional characteristics, registration categorization information indicating versions and registration dates of the robots, and categorization information indicating assignment codes and sequence numbers for services and schedules of the robots which are included in a data format of the manager code.

2. A method of operating an integrated robot management device for hyper robot implementation, the method comprising:
communicating, by a communication interface unit, with different kinds of robots provided in a space; and
installing, by a control unit, a manager code (F-code) for integrally managing the different kinds of robots on each of the different kinds of robots, authenticating the different kinds of robots on the basis of code information of the manager code, and collecting and analyzing data of robots that have been successfully authenticated,
wherein the method further comprises designating the different kinds of robots in the same space as a group and providing a service on the basis of the designated group,
the providing of the service comprises simultaneously performing operations of updating the manager code for the different kinds of robots designated as the group,
the method further comprises providing, by the control unit, analysis results of big data related to the different kinds of robots upon request from manufacturers of the different kinds of robots, and
the collecting and analyzing of the data comprises using manufacturer information, model information, function code information for categorizing each robot model specification and functional characteristics, registration categorization information indicating versions and registration dates of the robots, and categorization information indicating assignment codes and sequence numbers for services and schedules of the robots which are included in a data format of the manager code.
